(19) United States
(12) Patent Application Publication
(10) Pub. No.: US 2003/0023471 A1
(43) Pub. Date: Jan. 30, 2003

(54) Method and tool for achieving data consistency in an enterprise resource planning system

(76) Inventors: Edward W. Kettler III, Plano, TX (US); Prakash S. Kumar, Plano, TX (US); Andreas Wolf, Bruehl (DE)

Correspondence Address: David G. Wille, Esq., Baker Botts L.L.P., Suite 600, 2001 Ross Avenue, Dallas, TX, 75201-2980, US

(21) Appl. No.: 09/915,922

(22) Filed: Jul. 25, 2001

(51) Int. Cl. G06F 17/60

(52) U.S. Cl. 705/8

(57) ABSTRACT

One aspect of the invention is a method for achieving data consistency in an enterprise resource planning system. A first set of structural data is received and sent to two or more enterprise resource planning systems. The enterprise resource planning systems are associated with a single business or a related group of businesses and each maintains its own structural data. The sending of the first set of structural data is operable to cause each of the enterprise resource planning systems to create or change their own structural data.

### TECHNICAL FIELD OF THE INVENTION

This invention relates generally to enterprise resource planning systems more specifically to a method and tool for achieving data consistency therein.

### BACKGROUND OF THE INVENTION

Many businesses use enterprise resource planning systems to aid in managing their business. Large corporations sometimes employ a plurality of enterprise resource planning systems wherein different systems are used in different geographic regions. This may be particularly true in the case of multi-national corporations. Having multiple enterprise resource planning systems running in different geographic regions, rather than in a single location, may increase the overall performance of the systems, reduce networking costs and improve convenience with respect to issues such as maintenance. The use of multiple enterprise resource planning systems within a company or group of companies may also be advantageous where the company has distinct lines of business and/or distinct subsidiaries. Such an arrangement may also be useful in the event of a merger or acquisition such that the acquired company can continue to use its enterprise resource planning system during a transition period.

However, there are problems created when an organization uses multiple enterprise resource planning systems instead of using a single centrally located enterprise resource planning system. First, each system is independent from a data content perspective. Thus, a vendor defined in one system may not be defined in the other system or may be defined differently. Second, in an effort to solve the first problem, the achievement of data consistency with existing systems typically involves manual entry and verification of such entry for each system. Third, even where data consistency is attempted, data entered on one enterprise resource planning system may not get quickly replicated to other enterprise resource planning systems, thus causing errors. Fourth, unless the separate enterprise resource planning systems are controlled according to a common plan, differences in organizational and financial structural definitions may make the consolidation of data from the different systems difficult and expensive. In addition, corporate reorganizations may be costly to implement due to the disparate treatment of the organizational hierarchy in different systems.

### SUMMARY OF THE INVENTION

One aspect of the invention is a method for achieving data consistency in an enterprise resource planning system. A first set of structural data is received and sent to two or more enterprise resource planning systems. The enterprise resource planning systems are associated with a single business or a related group of businesses and each maintains its own structural data. The sending of the first set of structural data is operable to cause each of the enterprise resource planning systems to create or change their own structural data.

The invention has several important technical advantages. The invention allows updating structural data in multiple enterprise resource planning systems from a central location. Because data may be updated from a central location, it may be consistently updated in a timely manner in each of the enterprise resource planning systems. The ability to update the data from a central location not only reduces redundant data entry and verification, it decreases the number of errors as the data need only be entered once. By allowing central control of structural data, the invention increases the ease with which data from a plurality of enterprise resource planning systems may be shared by other applications.

### BRIEF DESCRIPTION OF THE DRAWINGS

For a more complete understanding of the present invention and the advantages thereof, reference is now made to the following descriptions, taken in connection with the accompanying drawings, in which:

FIG. 1 illustrates an exemplary general purpose computer that may be used with the present invention;

FIG. 2 illustrates a block diagram of an enterprise data architecture in which the present invention may be used;

FIG. 3 illustrates a block diagram of one embodiment of a data consistency tool constructed in accordance with invention;

FIG. 4 illustrates a block diagram of a sample organizational hierarchy that may be used in accordance with the invention;

FIG. 5 illustrates a method of updating or creating profit center structural data in accordance with the invention;

FIG. 6 illustrates a method of creating or updating cost center structural data in accordance with the invention;

FIG. 7 illustrates a method of creating or updating contract structural data in accordance with the invention; and

FIG. 8 illustrates a method of broadcasting updates to multiple enterprise resource planning systems in accordance with the invention.

### DETAILED DESCRIPTION OF THE INVENTION

The invention and its advantages are best understood by referring to FIGS. 1-8 of the drawings, like numerals being used for like and corresponding parts of the various drawings.

FIG. 1 illustrates a general purpose computer 10 that may be used to execute data consistency tool 32, one or more enterprise resource planning systems and/or other applications such as for example, general ledger systems and data warehouse applications in accordance with the invention. General purpose computer 10 may be adapted to execute any of the well known MS-DOS, OS-2, UNIX, MAC-OS, Linux and Windows operating systems or other operating systems. General purpose computer 10 comprises processor 12, random access memory (RAM) 14, read only memory (ROM) 16, mouse 18, keyboard 20, and input/output devices, such as printer 24, disk drives 22, display 26, and communications link 28. The present invention includes computer software that may be stored in RAM 14, ROM 16 or disk drives 22 and may be executed by processor 12. Communications link 28 may be connected to a telephone line, an antenna, a gateway, the Internet, or any other type of communication link. Disk drives 22 may include a variety of types of storage media such as, for example, floppy disk drives, hard disk drives, CD-ROM drives, or magnetic tape drives. Although this embodiment employs a plurality of disk drives 22, a single disk drive 22 could be used without departing from the scope of the invention. FIG. 1 only provides one example of a computer that may be used with the invention. The invention could be used on computers other than general purpose computers as well as on general purpose computers without conventional operating systems.

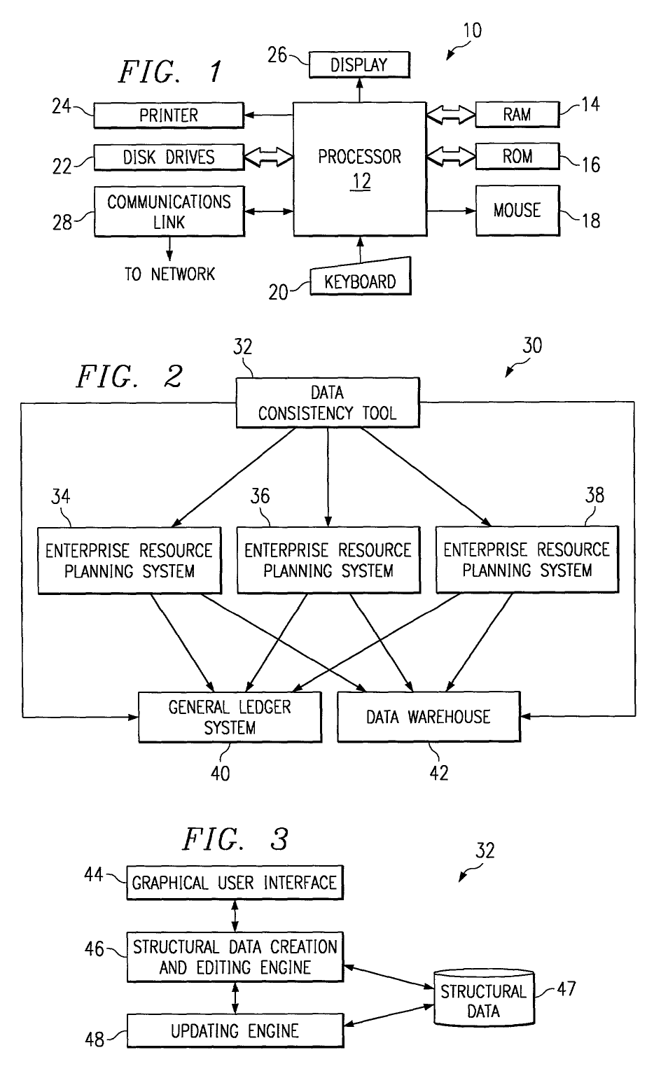

FIG. 2 illustrates an enterprise data architecture 30 constructed in accordance with the teachings of the invention. Enterprise data architecture 30 comprises data consistency tool 32, enterprise resource planning systems 34, 36 and 38, general ledger system 40, and data warehouse system 42. Data consistency tool 32 may comprise a part of enterprise resource planning system 34, enterprise resource planning system 36, and/or enterprise resource planning system 38 without departing from the scope of the invention. In addition, multiple data consistency tools 32 could be used (for example, one per enterprise resource planning system) to allow global updates to be made from multiple locations and broadcast to other enterprise resource planning systems. Although this example of enterprise data architecture 30 illustrates three enterprise resource planning systems 34, 36 and 38, any number greater than one could be used without departing from the scope of the invention. In addition, other applications such as general ledger system 40 and data warehouse 42 could be added or those illustrated could be subtracted without departing from the scope of the invention.

Although the invention may employ enterprise resource planning systems available from any vendor, this embodiment uses enterprise resource planning systems available from SAP. In addition, the general ledger system 40 and data warehouse system 42 are also applications available from SAP. Thus, this embodiment uses SAP application link enabling to communicate data between the various applications. Where enterprise resource planning systems from other vendors are used, a similar utility can be used or a utility can be written to allow the remote update of structural data in the enterprise resource planning system.

The term “structural data” is meant to refer to data concerning the structure of the enterprise with which each enterprise resource planning system 34, 36 and 38 is associated. In addition, the term structural data further comprises data concerning the relationship of the enterprise to third parties. For example, the structural data for a particular contract would include the name of the customer and information about the various cost centers and profit centers under which incoming expenses are to be charged under the contract. Structural data does not include actual cost and profit data that is gathered due to the operations under the contracts. Structural data may include the definition of profit centers, cost centers, or contracts. Because of the fundamental role of profit centers in enterprise resource planning systems, structural data associated with a profit center may include data about the profit center itself, data regarding a cost center associated with the profit center, and/or data associated with contracts associated with the profit center.

The invention allows each enterprise resource planning system 34, 36 and 38 to maintain its own structural data while allowing centralized updates using data consistency tool 32. Thus, some degree of consistency may be maintained over structural data in each of the enterprise resource planning systems 34, 36 and 38. When updates and/or additions to structural data are received using data consistency tool 32, they may be sent to each of the enterprise resource planning systems 34, 36 and 38.

In addition, updates to structural data may be sent to general ledger system 40 and/or data warehouse system 42. Because general ledger system 40 and data warehouse system 42 may obtain output from the enterprise resource planning systems 34, 36 and 38, the analysis of the data from the separate enterprise resource planning systems is more easily facilitated by maintaining the consistency of structural data for each of the enterprise resource planning systems 34, 36 and 38 and the applications (such as general ledger system 40 and/or data warehouse system 42). Thus, the invention promotes consistency of structural data at a high level, while allowing the operators of each enterprise resource planning system 34, 36 and 38 to have some local variation in the data maintained beyond the structural data which is maintained as consistent by data consistency tool 32.

Enterprise resource planning systems typically maintain structural data with respect to many aspects of the operation of a business, including, without limitation, cost centers, profit centers, and contracts. The invention allows the updating or creation of structural data of any type.

With respect to cost centers, various structural data may be maintained by each enterprise resource planning system 34, 36 and 38 and updated on an architecture wide basis using data consistency tool 32. Structural cost center data may include the placement of the cost center in one or more hierarchies. While some businesses place cost centers within a single hierarchy which is similar to or identical to the business unit's organization, other entities may choose to place cost centers in several hierarchies in order to provide for different types of analysis of cost center data. Accordingly, the invention allows for the cost center to be placed in two or more hierarchies and this hierarchy information may be maintained as structural data. In addition, the structural data may include various codes with respect to a legal entity associated with the cost center. In some cases, the data used by the enterprise resource planning system for a particular cost center may originate from one or more external computer systems and these may also be identified in structural data for a particular cost center. If the cost center is contract related, then the contract associated with the cost center may be maintained as structural data for the cost center. Similarly, the cost center may be associated with one or more profit centers. Other data that may be maintained include the date range for which the cost center is valid, the industry with which the cost center is associated, an identification of the persons responsible for administering the cost center, etc. Some of this data may be omitted or other data included without departing from the scope of the invention.

Similar information may be maintained for each profit center. Thus, the placement of the profit center in one or more hierarchies may be maintained as structural data for the profit center. In addition, the various hierarchies themselves, may be maintained as separate sets of structural data for enterprise resource planning systems 34, 36 and 38. A description of the profit center as well as its dates of validity may also be maintained. Again, some of this data may be omitted or other data maintained without departing from the scope of the invention.

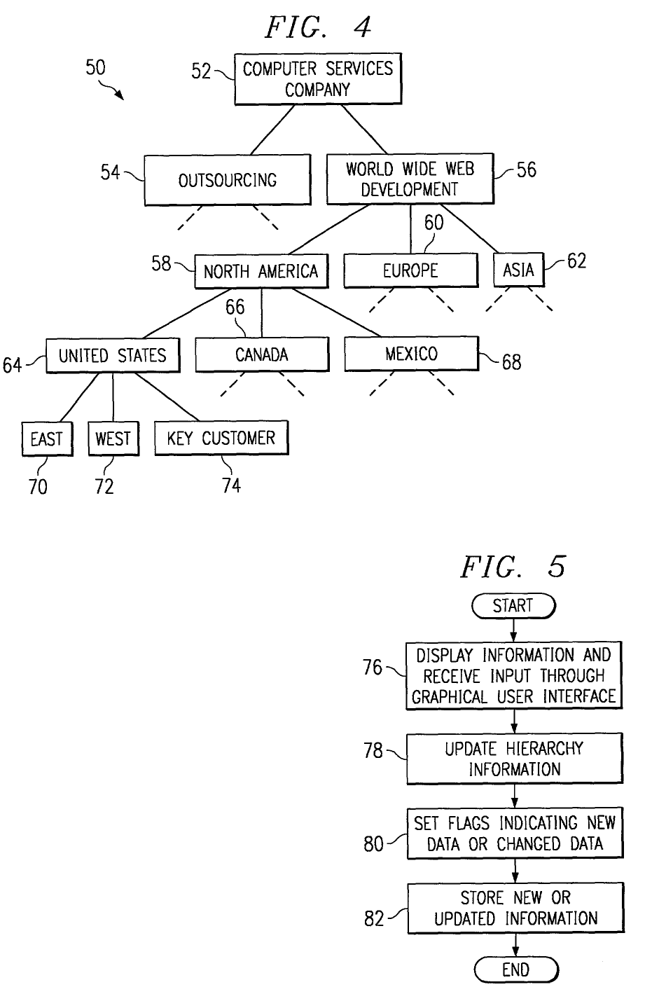

Structural data for contracts may include an identification of the customer along with other important information about the customer. Such information may also be created separately and maintained with a collection of customer data. In such case, only an identification of the customer might be used as structural data for the particular contract. In addition, the contract may have a plurality of line items associated with the contract. Each line item may include the cost center and profit center with which the line item is associated along with the placement of that line item in one or more hierarchies. Again, some of the structural contract data may be omitted or other data maintained without departing from the scope of the invention. An example of a hierarchy that could be used for a business is discussed in connection with FIG. 4 below. Data consistency tool 32 allows automated updates of hierarchy information when line items for particular contracts are changed. Thus, the invention may allow more efficient reorganization of the structural database in an enterprise resource planning system when a business is reorganized internally.

With respect to other categories of structural data, again, any type of data can be maintained and the invention does not place any restrictions on the data maintained and updated. The specification will provide details with respect to the updating of structural data with respect to contracts, cost centers, and profit centers, but the broad invention can be used for maintaining consistency of any kind of structural data.

FIG. 3 illustrates a block diagram of one possible embodiment of data consistency tool 32. In this embodiment, data consistency tool 32 comprises graphical user interface 44, structural data creation and editing engine 46, updating engine 48 and structural database 47. Data consistency tool 32, however, could be organized in any fashion without departing from the scope of the invention.

Graphical user interface 44 may be used to receive new structural data or updates to structural data that is to be changed in one or more enterprise resource planning systems. Graphical user interface 44 and/or structural data creation and editing engine 46 may also be configured such that they are operable to receive data concerning updates and/or changes to structural data from any type of external source (such as, for example, a file from another system).

The structural data that is to be maintained consistent across of all of the enterprise resource planning systems is maintained in structural database 47. However, each enterprise resource planning system 34, 36 and 38 can maintain its own copy of structural database 47 along with (optionally), its own additional structural data. Structural data creation and editing engine 46 receives input from graphical user interface 44 and/or external sources with respect to changes and/or additions to structural database 47. To facilitate update of the structural data in enterprise resource planning systems 34, 36 and 38 as well as in any other related applications (such as those illustrated in FIG. 2), structural data creation and editing engine 46 provides appropriate data to updating engine 48 so that updating engine 48 may facilitate the updates. In addition, structural data creation and editing engine 46 handles automatic updates of hierarchical information when other items are changed. For example, if the placement of a profit center and a particular hierarchy is changed, then the profit center needs to be removed from its former place in the hierarchy and moved to a new place in the hierarchy. Similarly, because a profit center may have one or more cost centers associated with it, the movement of a profit center in the hierarchy may also cause a need to change the hierarchy information for the associated cost center. Similarly, when a new line item is added to a contract, the hierarchy structural data is updated with respect to the profit center and cost center associated with the new line item. In this embodiment, because hierarchy information can be time consuming to update, a collection of hierarchical changes may be made simultaneously after loading the hierarchy information into memory. By grouping a plurality of changes to the hierarchy, the invention processes such information in a more efficient manner.

Updating engine 48 may update the structural data in one or more of the enterprise resource planning system 34, 36 and 38 on a real-time or periodic basis. The operation of one embodiment of updating engine 48 will be discussed in more detail in connection with FIG. 8 below.

FIG. 4 illustrates a portion of an example hierarchy where contracts, cost centers, and/or profit centers may be placed in connection with the operation of an enterprise resource planning system. In this example, computer services company 52 is subdivided into an outsourcing line of business 54 and a world wide web development line of business 56. The world wide web development line of business 56 is further subdivided into three geographical regions: North America 58, Europe 60 and Asia 62. The North America 58 region is further divided into country regions United States 64, Canada 66 and Mexico 68. The United States is further subdivided into an East 70, West 72, and key customer 74 region. Because some customers may conduct a large volume of business with computer services company 52, such key customer 74 may be assigned its own place in the organizational hierarchy rather than being placed within a geographical hierarchy.

Cost centers, profit centers and/or contracts may be placed anywhere within this type of hierarchy in connection with the enterprise resource planning system. While the illustrated example is not very complex, large organizations can easily have complex hierarchical structures. If the computer services company 52 decides to reorganize itself internally, it can cause large problems for operators of the engineering resource planning system who may have to manually reorganize structural data associated with contracts, cost centers, and profit centers. For example, computer services company 52 may decide to eliminate the country organization for North America and instead simply divide North America into East 70, West 72 and key customer 74 thus eliminating the intermediate country level in the hierarchy. In existing systems, profit center, cost center and contract structural data that had been placed in this hierarchy may need to be manually re-entered to reflect its new placement in the hierarchy.

The invention allows automatic updates to the hierarchical information associated with cost center, profit center and/or contract data. Thus, the invention allows a business to internally reorganize itself without causing significant interference with the operation of the engineering resource planning system. To achieve automatic reorganization, data consistency tool 32 receives as input the new location of each line item and data consistency tool 32 will automatically update the hierarchy information for each cost center and profit center associated with a particular line item.

FIG. 5 illustrates an example of the steps that may be taken by structural data creation and editing engine 46 to update a profit center in accordance with the invention. Some of these steps may be omitted or other steps added without departing from scope of the invention. In the case of the update of other structural data, a similar procedure could be used such that data to be added or changed is received and then send to associated enterprise resource planning systems. In step 76, information is displayed using graphical user interface 44 and input is received through graphical user interface 44. In step 78, the appropriate hierarchy information is updated with respect to the profit center. In step 80, flags are set indicating either that new data has been added or that data has been changed with respect to this profit center and the associated hierarchy. These flags may be used by updating engine 48 to determine which data needs to be broadcast to each enterprise resource planning system 34, 36 and 38 and to other applications such as general ledger system 40 and data warehouse system 42. In step 82, the new or updated information regarding the profit center is stored in structural database 47. Although this embodiment uses flags to indicate data that needs to be sent to other enterprise resource planning systems, any method could be used to designate such data without departing from the scope of the invention. For example, the data to be changed could be stored in a file, a database, or in any kind of data structure in memory. An embodiment of the invention need only have some way of determining what data needs to be sent to other enterprise resource planning systems for update. This could even include sending the entire contents of the structural database 47.

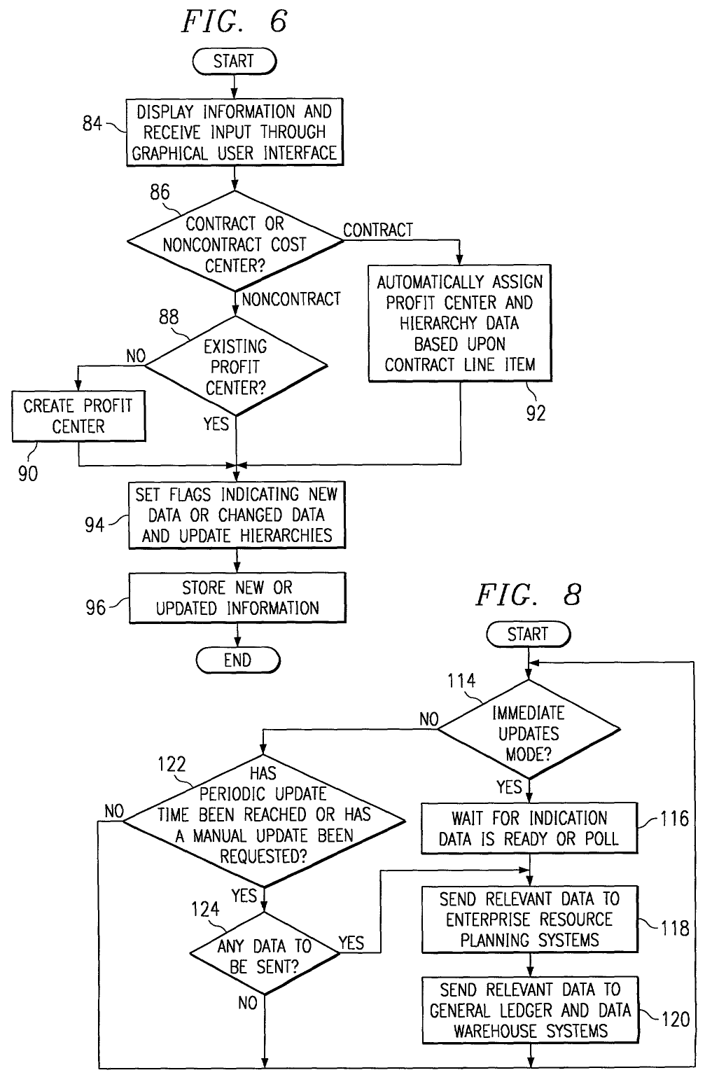

FIG. 6 illustrates an example of a method for updating a cost center using data consistency tool 32. Some of the steps may be omitted or others added without departing from the scope of the invention. In step 84, information is displayed and input is received through graphical user interface 44.

In step 86, it is determined whether or not the cost center is a contract cost center or a non-contract cost center. If the cost center is a contract cost center then the profit center and hierarchy data is automatically assigned in step 92 based upon the contract line item with which the cost center is associated. If the cost center is a non-contract cost center then it is determined in step 88 whether there is an existing profit center associated with the new cost center. If not, then a profit center is created in step 90. If so, then flags are set in step 94 indicating that this cost center data was newly created or has been changed. Also, the appropriate hierarchies associated with the cost center are updated in step 94. In step 96, new or updated cost center data is stored in structural database 47.

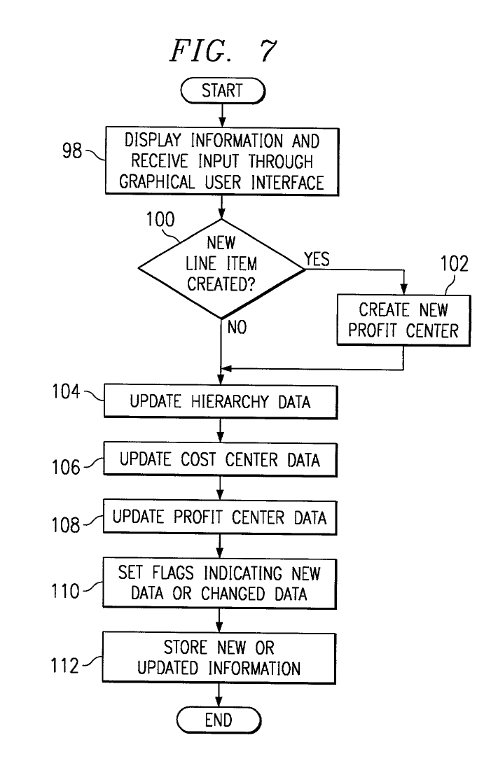

FIG. 7 illustrates an example of a method for updating or creating structural data associated with a contract using data consistency tool 32. In step ⁹8, information is displayed and input is received from a user using graphical user interface 44. In each of the methods illustrated in FIGS. 5, 6 and 7, information may be received by data consistency tool 32 through some other type interface without departing from the scope of the invention.

In step 100, it is determined whether a new line item was created for the contract. If so, then a new profit center is created in step 102. If not, then the appropriate hierarchy data is updated in step 104. After updating the appropriate hierarchy data, the appropriate cost center data is updated in step 106 and profit center data updated in step 108. In step 110, flags are set to indicate that the particular structural data is either new or changed since the last broadcast of updates by updating engine 48. The new or updated structural data is stored in structural database 47 in step 112.

FIG. 8 illustrates an example of a method that may be used by updating engine 48 to update the structural data of enterprise resource planning systems 34, 36 and 38, a general ledger system 40, and/or data warehouse 42. In steps 114, it is determined whether or not updates are to be immediate or not. In this embodiment, updates are immediate or periodic with respect to each of the enterprise resource planning systems 34, 36 and 38 as well as data warehouse 42 and general ledger system 40 in the aggregate. That is, updates are immediate as to all applications or are periodic as to all applications. In an alternative embodiment, the process illustrated in FIG. 8 could be used to with respect to each application receiving structural data updates from data consistency tool 32 on an application-by-application basis. Accordingly, each enterprise resource planning system 34, 36 and/or 38 as well as general ledger 40 and data warehouse 42 could set appropriate indicators in data consistency tool 32 to indicate whether or not they desire immediate updates or periodic updates. Thus, updating engine 48 may be programmed to cater to each specific application individually.

If immediate updates were desired in step 114, then updating engine 48 may either wait for an indication that data is ready to be sent from structural data creation and editing engine 46 or updating engine 48 may poll structural database 47 to determine whether or not that structural data has been changed. In step 118, relevant data is sent to enterprise resource planning systems 34, 36 and 38. In step 120, data is sent to other applications such as general ledger system 40 and/or data warehouse system 42. The process then repeats itself.

If immediate updates were not requested, then it is determined in step 122 whether the time for periodic updates has been reached (for example, once a day or once a week) or it is determined whether or not a manual update has been requested by one or more applications or by the operator of data consistency tool 32. The manual update feature allows important updates to be sent prior to the time that a periodic update would normally be sent. If the time has been reached or a manual update has been requested, then it is determined in step 124 whether there is any data to be sent by examining the condition of various flags in structural database 47. If structural data is to be sent, then it is sent using steps 118 and 120 and the process repeats itself. If no data is available to be sent then the process simply repeats itself.

Although the present invention has been described in detail, it should be understood that various changes, substitutions, and alterations can be made hereto without departing from the spirit and scope of the invention as defined by the appended claims.

To aid the Patent Office and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for”, or “step for” are used in the particular claim.

What is claimed is:

1. A method for achieving data consistency in an enterprise resource planning system, comprising:
receiving a first set of structural data;
sending the first set of structural data to two or more enterprise resource planning systems;
wherein at least two of the enterprise resource planning systems are associated with a single business or related group of businesses;
wherein each of the at least two enterprise resource planning systems maintains its own structural data; and
wherein the sending of the first set of structural data is operable to cause each of the enterprise resource planning systems to create or change their own structural data.

2. The method of claim 1, wherein the first set of structural data comprises structural data for a first contract wherein at least some transactions under the contract will be handled through a first profit center.

3. The method of claim 1, wherein the first set of structural data comprises structural data for a first cost center associated with a first profit center.

4. The method of claim 1, wherein the first set of structural data comprises structural data for a first profit center.

5. The method of claim 1, wherein the first set of structural data comprises data associated with the addition of a new contract to the at least two enterprise resource planning systems.

6. The method of claim 1, wherein the first set of structural data comprises data associated with the changing of the structural data for a first contract for use in the at least two enterprise resource planning systems.

7. The method of claim 1 wherein the first set of structural data comprises data associated with one of the following selected from the group consisting of:
the addition of a first profit center to the at least two enterprise resource planning systems;
the changing of the structural data for a first profit center for use in the at least two enterprise resource planning systems;
the addition of a new cost center to the at least two enterprise resource planning systems; and
the changing of the structural data for a cost center for use in the at least two enterprise resource planning systems.

8. The method of claim 2 wherein the structural data for the first contract further comprises data identifying the location of the first profit center in a plurality of hierarchies.

9. The method of claim 2,
wherein the structural data for the first contract further comprises data identifying the location of the first profit center in at least one hierarchy; and
wherein the creation or changing of the structural data for the first contract causes an automatic update to the at least one hierarchy in the at least two enterprise resource planning systems.

10. The method of claim 9, wherein the creation or changing of the structural data for the first contract causes an automatic update to structural data associated with the first profit center and a first cost center associated with the first contract in the at least two enterprise resource planning systems.

11. The method of claim 1, wherein the sending of the first set of structural data occurs nearly immediately after the first set of structural data was received where such first set of structural data comprises valid data.

12. The method of claim 1, wherein the sending of the first set of structural data occurs some time interval after the first set of structural data was received in accordance with a periodic update schedule.

13. The method of claim 1, further comprising:
sending the first set of structural data to a general ledger system and a data warehousing system.

14. The method of claim 1,
wherein the at least two enterprise resource planning systems comprise SAP enterprise resource planning systems; and
wherein the first set of structural data is sent to the at least two enterprise resource planning systems using the application link enabling facility supplied by SAP.

15. A tool for achieving data consistency in an enterprise resource planning system, comprising:
a computer readable storage medium;
computer software stored on the computer readable storage medium and operable to;
receive a first set of structural data;
send the first set of structural data to two or more enterprise resource planning systems;
wherein at least two of the enterprise resource planning systems are associated with a single business or related group of businesses;
wherein each of the at least two enterprise resource planning systems maintains its own structural data; and
wherein the sending of the first set of structural data is operable to cause each of the enterprise resource planning systems to create or change their own structural data.

16. The tool of claim 15, wherein the first set of structural data is received through a graphical user interface.

17. The tool of claim 15, wherein the first set of structural data comprises a file.

18. The tool of claim 15, wherein the first set of structural data comprises structural data for a first contract wherein at least some transactions under the contract will be handled through a first profit center.

19. The tool of claim 15, wherein the first set of structural data comprises data associated with the addition of a new contract to the at least two enterprise resource planning systems.

20. The tool of claim 15, wherein the first set of structural data comprises data associated with the changing of the structural data for a first contract for use in the at least two enterprise resource planning systems.

21. The tool of claim 18, wherein the structural data for the first contract further comprises data identifying the location of the first profit center in a plurality of hierarchies.

22. The tool of claim 18,
wherein the structural data for the first contract further comprises data identifying the location of the first profit center in at least one hierarchy; and
wherein the creation or changing of the structural data for the first contract causes an automatic update to the at least one hierarchy in the at least two enterprise resource planning systems.

23. The tool of claim 22, wherein the creation or changing of the structural data for the first contract causes an automatic update to structural data associated with the first profit center and a first cost center associated with the first contract in the at least two enterprise resource planning systems.

24. The tool of claim 15, wherein the computer software is further operable to:
send the first set of structural data to a general ledger system and a data warehousing system.

25. The tool of claim 15,
wherein the at least two enterprise resource planning systems comprise SAP enterprise resource planning systems; and
wherein the first set of structural data is sent to the at least two enterprise resource planning systems using the application link enabling facility supplied by SAP.
